(19) United States
(12) Patent Application Publication
(10) Pub. No.: US 2019/0378017 A1
(43) Pub. Date: Dec. 12, 2019

(54) SYSTEM AND METHOD FOR IMPLEMENTING A NEURAL NETWORK

(71) Applicant: Sun-Yuan Kung, Princeton, NJ (US)

(72) Inventor: Sun-Yuan Kung, Princeton, NJ (US)

(21) Appl. No.: 16/409,361

(22) Filed: May 10, 2019

Related U.S. Application Data
(60) Provisional application No. 62/683,680, filed on Jun. 12, 2018.

(51) Int. Cl. G06N 3/08; G06N 3/063; G06N 5/04; G06N 20/10; G06F 9/50

(52) U.S. Cl. CPC G06N 3/084; G06N 3/082; G06F 9/5027; G06N 5/046; G06N 20/10; G06N 3/063

(57) ABSTRACT

In a neural network, hidden layers are modified by supplying input data, an output label, and internal teaching labels to the neural network; causing the neural network to process the input data through the hidden layers and outputting a result of the processing for comparison with the output label; supplying the internal teaching labels to the hidden layers and calculating scores for the hidden layers based on the internal teaching labels; and modifying the hidden layers or hidden nodes based on the calculated scores and the comparison of the processing result with the output label. The modifications to the hidden layers or hidden nodes may involve pruning hidden nodes by dropping lower scoring nodes; reducing a number of bits in computations and outputs; reducing a number of bits in selected nodes; bypassing lower scoring nodes; modifying activation functions of the hidden nodes based on the calculated scores; and/or adding hidden layers or hidden nodes.

This application claims the benefit of Provisional U.S. Patent Appl. Ser. No. 62/683,680, filed Jun. 12, 2018, the specification, drawings, and appendix of which are incorporated by reference herein.

### BACKGROUND OF THE INVENTION

### 1. Field of the Invention

The invention relates to a system and method for implementing a neural network by enhancing external learning methods with an internal learning paradigm.

In addition to enhancing external methods The method and system of the invention may be used to construct monotonically increasing discriminant neural networks.

### 2. Description of Related Art

The neural networks referred to in this disclosure are artificial neural networks which may be implemented on electrical circuits to make decisions based on input data. A neural network may include one or more layers of nodes, where each node may be implemented in hardware as a calculation circuit element to perform calculations. Neural networks are widely used in pattern recognition (e.g., object identification in images, face recognition), sequence recognition (e.g., speech, character, gesture recognition), medical diagnosis etc.).

To simplify the terminology, an input layer of nodes that is exposed to the input data and an output layer that is exposed to the output are referred to as visible layers because they can be observed outside the neural network. The layers between the input layer and the output layer are referred to as hidden layers. The hidden layers may include nodes to carry out calculations that are propagated from the input layer through the hidden layers to the output layer. The calculations implemented using calculation circuit elements can be linear calculations (e.g., multiplication by weight values, summation, convolution, binary thresholding) or non-linear calculation (e.g., non-linear functions).

The architecture of a neural network may include multiple layers of nodes that perform certain types of linear or non-linear calculations. Each node in the neural network may be associated with a value that can be calculated and updated based on the values associated with nodes in an immediate adjacent layer and parameters (referred to as synaptic weights) associated with the edges connecting the node to those nodes in the immediate adjacent layer. For example, in a forward propagation calculation of the neural network, the value associated with a node in a current layer may be calculated and updated based the nodes in the prior layer and the synaptic weights associated with the edges connecting the nodes in the prior layer to the node in the current layer.

Adaptation of such a neural network to perform a specific task involves training the neural network for the specific task. The training may include adjusting the synaptic weights associated with edges. For example, to identify objects in images, a computer system may optionally first extract certain feature values from images containing known objects, where the feature values can be generated by applying feature extraction operators to the pixels of the image, or can be the pixel values themselves. The computer system can then apply the neural network to the extracted feature values to determine if the output data of the neural network properly identify the known objects (referred to as the training data). Based on the errors detected in the training data, the computer system may adjust the synaptic weights associated with edges connecting to nodes of the neural network to reduce the errors detected in the training data. The adjustment of synaptic weights may include multiple iterations which is also referred to as the learning process.

The learning process for a neural network of the type will typically include both a forward propagation that generates an output based on the input data, and a backward propagation (referred to as backpropagation) to adjust parameters (e.g., synaptic weights associated with edges) of the neural network. The backpropagation error function can be an analog function or a differentiable error function, and the backpropagation can be based on surrogate functions (e.g., amplified gradients). The output layer of the neural network serves as supervision that controls the adjustment of parameters of hidden layers of the neural network. In a multiple-layered neural network (e.g., where the number of layers is at least four including the input layer and the output layer), nodes of at least some layers are indirectly coupled to the teacher. Thus, the impact of the teacher is applied indirectly through the backpropagation.

There are two inherent problems with traditional backpropagation Learning: (1) backpropagation can in general only be used for parameter learning of very deep learning networks (DLNs), leaving the task of finding optimal structure to trial and error, and (2) backpropagation learning on deep nets may suffer from vanishing/exploding gradients of an external optimization metric (EOM), which in turn results in the “curse of depth” problem.

With respect to the “curse of depth” problem, when the neural network includes numerous layers (e.g., the number of layers is greater than 100), the dimensionality of the neural network can be a significant large number, where the dimensionality of the neural network is defined as the product of the number of layers (depth) and the number of nodes per layer. The large number of layers, directly related to the large dimensionality, results in the so called “curse-of-depth” problem where the teacher cannot meaningfully impact the parameters of nodes due to the number of in-between layers between the teacher and the nodes. The “curse-of-depth” problem may significantly increase the training time and/or limit the accuracy of the neural network.

To overcome the above-described and other technical problems, implementations of the present invention replace backpropagation learning with a paradigm in which internal teaching “labels” (ITLs) are provided directly to the hidden nodes of the neural network, with internal (rather than external) optimization metrics (IOMs) being used to evaluate the hidden layers. Also, in further implementations of the invention, systems and methods are provided that construct a neural network where each hidden layer of the neural network includes supervision nodes (referred to as inheritance nodes). Because of the presence of the supervision in each hidden layer, such constructed neural networks may reduce the usage of hardware resources, improve the accuracy of the neural network, and achieve faster training as compared to backpropagation from the teacher in the final layer.

Conceptually, the use of internal teaching labels and internal optimization metrics in implementations of the invention may be thought of as a step beyond the notion of Internal Neuron's Explainablility (INE), championed by DARPA's XAI (or AI3.0). Practically, the implementations of the invention described below facilitate structure/parameter NP-iterative learning (“NP” referring to computationally difficult problems such as pattern matching and optimization) for supervised deep compression/quantization: simultaneously trimming hidden nodes and raising accuracy.

### SUMMARY OF THE INVENTION

It is accordingly an objective of the present invention to provide solutions to the aforementioned problems with conventional backpropagation-based neural network teaching methods and systems.

It is a further objective of the invention to provide teaching methods for implementing neural networks that offer improved processing speed, prediction accuracy, hardware cost, and power saving.

These and other objectives are achieved by a method and/or system of implementing a neural network in which, instead of modifying the hidden nodes by backpropagation from the output to the input through the hidden layers in a reverse sequence, the neural network is taught by modifying hidden layers by the steps of: (a) supplying input data, an output label, and internal teaching labels to the neural network, (b) causing the neural network to process the input data through the hidden layers and outputting a result of the processing for comparison with the output label, (c) supplying the internal teaching labels to the hidden layers and calculating scores for the hidden layers based on the internal teaching labels, (d) modifying the hidden layers based on the calculated scores and the comparison of the processing result with the output label.

The objectives are further achieved by implementations of the method and/or system of the invention in which the step of calculating scores for the hidden layers involves calculating the following score function of W, X, and ITL, to evaluate critical information embedded in any one of the nodes of any one of the hidden layers:

DI(W)=function(W;X,ITL)

where W is one of a lower-dimensional or reduced-rank transformation matrix to a subspace or subset of nodes of interest, X is the training dataset, and ITL is the internal teacher labels.

By way of example and not limitation, the score function used to evaluate the hidden layers may take the following form:

DI(W)=tr([W^{T}SW+ρI]⁻¹[W^{T}S_{B}W]),

where W is one of a lower-dimensional or reduced-rank transformation matrix to a subspace or subset of nodes of interest, S is a center-adjusted scatter matrix given by S=XX^{T}=S_{B}+S_{W}, S_{B} denotes a between-class scatter matrix and S_{W} denotes a within-class scatter matrix calculated by Fisher's Classical discriminant analysis, and ρ is a ridge parameter incorporated to safeguard numerical inversion of S.

In an exemplary implementation where W is one of a lower-dimensional or reduced-rank transformation matrix to a subspace or subset of nodes of interest, a value of the i-th node may be given by a diagonal matrix W_{i_keep}, wherein DI(W_{i_keep})=FDR (the Fisher Discriminant Ratio), and:

$${W}_{{i}_{keep}} = [ \begin{matrix}0 & 0 & … & 0 & 0 \\ 0 & ⋱ & … & … & 0 \\ ⋮ & … & \begin{matrix}0 & & \\ & 1 & \\ & & 0\end{matrix} & … & ⋮ \\ 0 & … & … & ⋱ & 0 \\ 0 & 0 & … & 0 & 0\end{matrix} ]$$

where “0” on the diagonal indicates dropping its corresponding node and “1” on the diagonal indicate retaining its corresponding node. Alternatively, the transformation matrix W_{i_keep} may contain multiple “1”s on the diagonal, where multiple “1”s indicate retaining multiple corresponding nodes and, if the neural network is a convolution network, a value of “1” or “1”s on the diagonal of the diagonal matrix W_{i_keep} may be used to indicate retaining one or multiple corresponding image channels.

In another exemplary implementation where W is one of a lower-dimensional or reduced-rank transformation matrix to a subspace or subset of nodes of interest, loss of information upon dropping the i-th node may be shown by a diagonal matrix W_{i_drop}, wherein DI(W_{i_drop})≡DI(I)−DI(W_{i_drop}), and:

$${W}_{{i}_{drop}} = [ \begin{matrix}1 & 0 & … & 0 & 0 \\ 0 & ⋱ & … & … & 0 \\ ⋮ & … & \begin{matrix}1 & & \\ & 0 & \\ & & 1\end{matrix} & … & ⋮ \\ 0 & … & … & ⋱ & 0 \\ 0 & 0 & … & 0 & 1\end{matrix} ]$$

where “0” on the diagonal indicates dropping a corresponding node and “1” on the diagonal indicate retaining a corresponding node. Alternatively, the transformation matrix W_{i_drop} contains multiple “0”s on the diagonal, where multiple “0”s indicate retaining multiple corresponding nodes and, if the neural network is a convolution network, and a value of “0” or “0”s on the diagonal of the diagonal matrix, W_{i_keep} may be used to indicate dropping one or multiple corresponding image channels.

In another implementation of the invention, the neural network is a multilayer percetron network, a value of the i-th node is given by a diagonal matrix W_{i_keep}, wherein DI(W_{i_keep}) and the loss of information upon dropping the i-th node is shown by a diagonal matrix W_{i_drop}, wherein DI(W_{i_drop})≡DI(I)−DI(W_{i_drop}). Alternatively, in an implementation in which the neural network is a convolution neural network, a value of the i-th node is given by a diagonal matrix W_{i_keep}, wherein DI(W_{i_keep}, and the loss of information upon dropping the i-th node is shown by a diagonal matrix W_{i_drop}, wherein DI(W_{i_drop})≡DI(I)−DI(W_{i_drop}).

In addition to various hidden layer evaluation methods, the method and system of the invention may also encompass a variety of exemplary methods of modifying the network structure in response to the evaluation results, including any combination of: pruning hidden nodes by dropping lower scoring nodes; reducing a number of bits in computations and outputs; reducing a number of bits in selected nodes; bypassing lower scoring nodes; modifying activation functions of the hidden nodes based on the calculated scores; and/or adding hidden layers or hidden nodes.

An exemplary non-limiting method of adding one or more hidden layers and/or hidden nodes includes steps of:
(a) adding a first set of inheritance nodes to a first hidden layer using a discriminative analysis of input data;
(b) performing both a forward propagation of the input data and a backpropagation from the output to adjust parameters of the first set of inheritance nodes and original nodes of the first hidden layer;
(c) adding a second set of inheritance nodes to a second hidden layer using the discriminative analysis of input data processed by the first hidden layer;
(d) using the second set of inheritance nodes as a teacher for the second hidden layer by performing forward propagation of the input data and backpropagation from the output to adjust parameters of the second set of inheritance nodes and original nodes of the second hidden layer, and
(e) optional repeating steps (c) and (d) for additional hidden layers.

According to another alternative or additional aspect of the above-described implementations of the invention, the discriminative analysis of input data includes a step of calculating synaptic weights associated with edges connected to the inheritance nodes using Fisher linear discriminant analysis, by calculating S̅⁻¹ Δ, where S̅⁻¹ is an inverse covariance matrix of the input data and A is an inter-class vector for a supervised learning process where a number of number of classes is given.

In additional alternative or additional aspects of the various implementations of the invention, the step of supplying the output label to selected hidden layers may, optionally, involve alternating calculating scores for the hidden layers based on the internal teaching labels with calculating scores for the hidden layers based on the output label, the output label may be a continuous value or a discrete label, and the internal teaching labels may be discrete labels, or selected for end-user XAI explainability and/or robust inference. Also, the internal teaching labels may be different for different hidden layers, and/or may include the output label.

Based on the above, those skilled in the art will appreciate that none of the illustrated examples, implementations and embodiments are intended to be limiting, and that modifications and variations thereof will occur to those skilled in the art. For example, it is also within the scope of the invention to modify multiple network structures by using and cross-referencing calculated hidden layer scores of multiple networks, and to use the internal teaching labels are also used to evaluate layer sizes of modified network structures.

The disclosure will be understood more fully from the detailed description given below and from the accompanying drawings of various embodiments of the invention. The drawings, however, should not be taken to limit the disclosure to the specific embodiments, but are for explanation and understanding only.

### BRIEF DESCRIPTION OF THE DRAWINGS

FIG. 1 illustrates a monotonically-increasing discriminant neural network (MIND-Net) according to an implementation of the present invention in which a neural network is modified by adding one or more hidden layers or nodes.

FIG. 2 depicts a flow diagram of a method to construct a MIND-Net of FIG. 1.

FIGS. 3A-3D illustrate an exemplary sequence of the construction of a MIND-Net of FIG. 2.

FIG. 4 illustrates a completed MIND-Net constructed according to the sequence illustrated in FIG. 2.

FIG. 5 is a flow diagram of a method to construct a MIND-Net by augmenting layers with backpropagation nodes according to a variation of the sequence of FIGS. 2-4.

FIG. 6 illustrates a comparison of the MIND-Net with a backpropagation neural network according to an implementation of the present invention.

FIG. 7 depicts a block diagram of a computer system operating in accordance with one or more aspects of the present invention.

FIG. 8 is a flow diagram of the input data flow from the bottom input layer upward to all the hidden layers and finally reach the output layer in a multilayer network, wherein the network receives input data at the input nodes and only one kind of desired output value or label at the output nodes.

FIG. 9 illustrates a conventional external learning paradigm, in which the teacher values or teacher labels are made available only to the output nodes.

FIG. 10 illustrates an internal learning paradigm in which internal teacher labels are made accessible to some or all the hidden nodes.

FIG. 11 is a flow diagram for the internal learning paradigm of FIG. 10, in which the original label is sent to all hidden nodes to indicate that the currently presenting input vector has the ground truth of belonging to the B label/class.

FIG. 12 illustrates mathematically why internal optimization metrics (IOM) scores are effective and may be used to automatically differentiate good and bad nodes—an important process for node pruning and node selection strategies.

FIG. 13 illustrates in real image data why the IOM scores are effective and may be used to automatically differentiate good and bad nodes.

FIG. 14 illustrates the process (before and after) of the node pruning strategy, and also an aspect of the process (before and after) of the node selection strategy.

FIG. 15 illustrates an NP iterative learning method, in which the method trims nodes by iteratively repeating: (i) Net Updating to remove the low-score hidden neurons based on the supervised TOM and (ii) Parameter Updating via external backpropagation learning.

FIG. 16 illustrates the effect of the pruning strategy of FIGS. 14 and 15 on accuracy and processing speed, which can yield noticeable improvement in both network reduction and performance enhancement when starting with an oversized (fat) base network.

FIG. 17 is a map of quantization strategy, showing how the importance varies horizontally (in layers) versus vertically (in nodes), as a result of which a strategy may be worked out so that the network complexity can be effectively reduced by assigning less valuable nodes (and the associated connections) with a smaller number of bits, both in terms of storage and computations.

FIG. 18 depicts an internal teacher label that can be designed for end-user explainability as in XAI.

### DETAILED DESCRIPTION OF EMBODIMENTS OF THE INVENTION

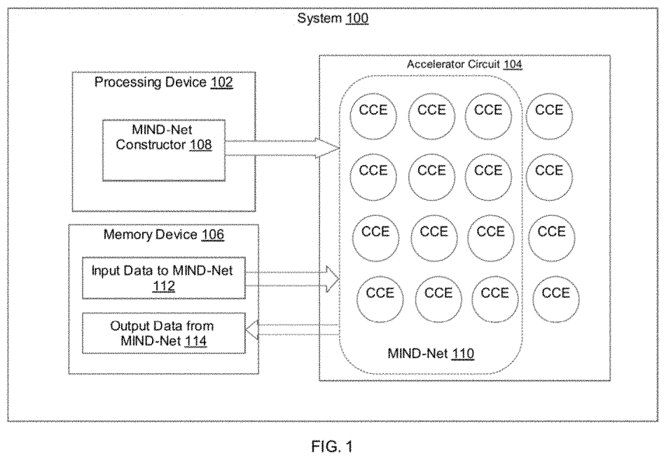

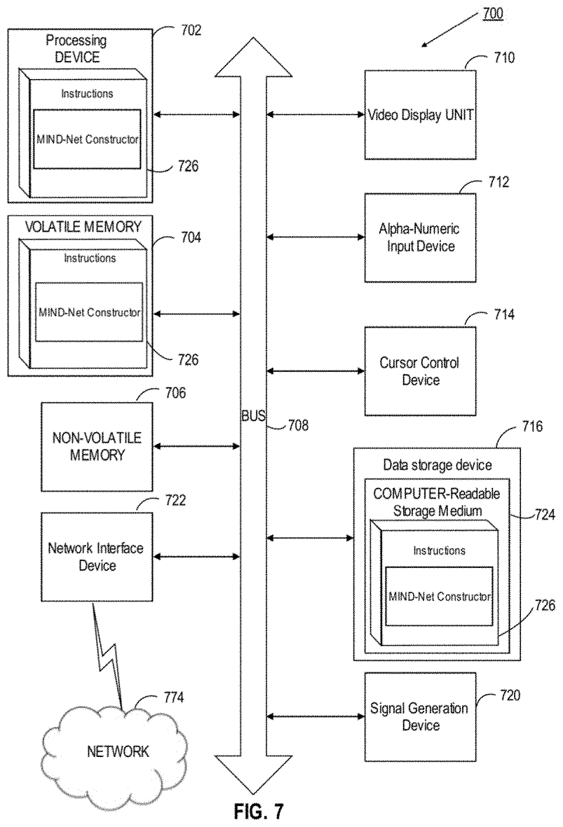

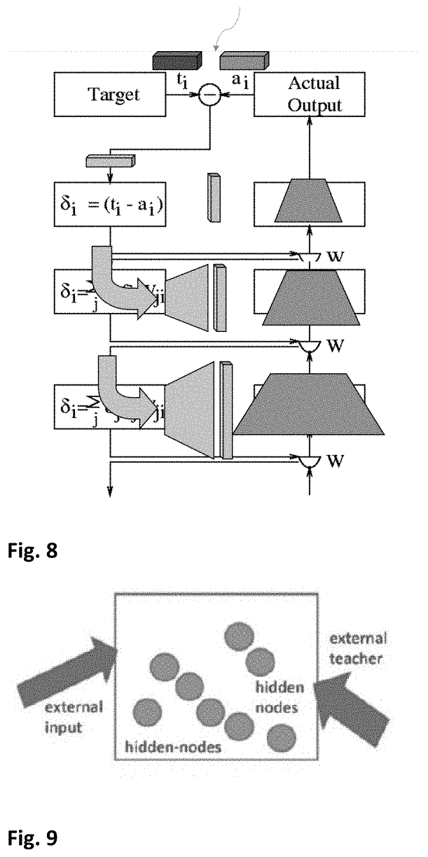

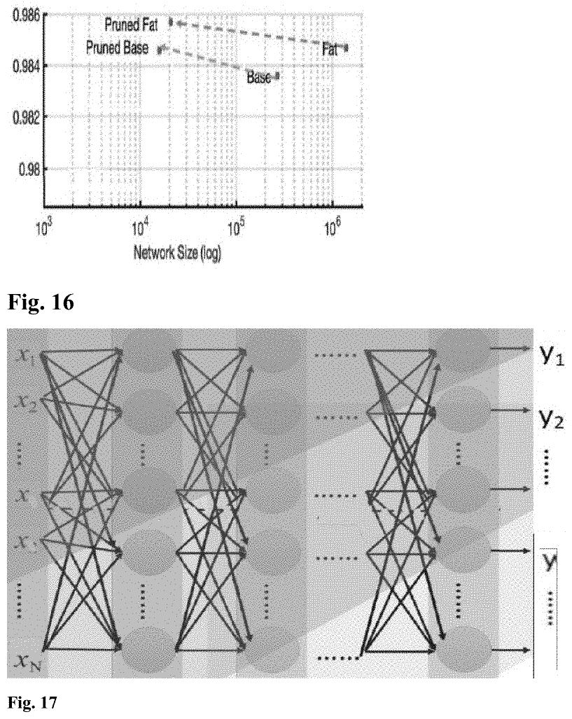

FIGS. 8-18 illustrate a new internal learning paradigm for implementing a neural network that replaces a conventional backpropagation learning paradigm with an internal learning paradigm. The method illustrated in FIGS. 8-18 may be implemented on hardware such as the hardware illustrated in FIG. 7 to provide a method and system that utilizes internal optimization metrics (IOMs) and internal teaching labels (ITLs) to evaluate hidden layers of the neural network, the results of the evaluation being used to modify or configure the internal layers or nodes or the neural network, for example by pruning the layers or nodes. In addition, the method of the invention may be used in connection with a method of adding hidden layers or nodes, which is illustrated in connection with FIGS. 1-6, the description of which follows the description of FIGS. 8-18.

By way of background, the difference between the conventional backpropagation method and the internal learning method may be understood in connection with FIG. 8. As shown in FIG. 8, the multi-layer neural network of FIG. 8 comprises one input layer (with input nodes), several hidden layers (with varying hidden nodes in each layers), and one output layer (with output nodes). The input data flows from the bottom input layer upward to all the hidden layers and finally reach the output layer. In this way, the network receives input data at the input nodes and only one kind of desired output value or label at the output nodes.

In backpropagation learning, the teacher values or teacher labels are made available only to the output nodes. Such teacher labels are called external teacher labels and the learning method utilizing the labels may be referred to as an external learning paradigm. Backpropagation learning is a gradient decent learning method, meaning that the error gradients are computed at the output nodes and propagated from the top output layer downward to all the hidden layers until finally reaching the bottom input layer. Therefore, error signal flow is said to be backpropagated.

As explained above, there exist two inherent problems with traditional backpropagation learning: (1) backpropagation is only used for parameter learning of deep learning networks or deep nets (DLNs), leaving the task of finding optimal structure to trial and error, and (2) backpropagation learning on deep nets may suffer from vanishing/exploding gradients of an external optimization metric (EOM), which in turn results in the above-described curse of depth problem in which the teacher cannot meaningfully impact the parameters of nodes due to the number of in-between layers between the teacher and the nodes. To mitigate these problems, the internal learning paradigm is used for the classification-type applications.

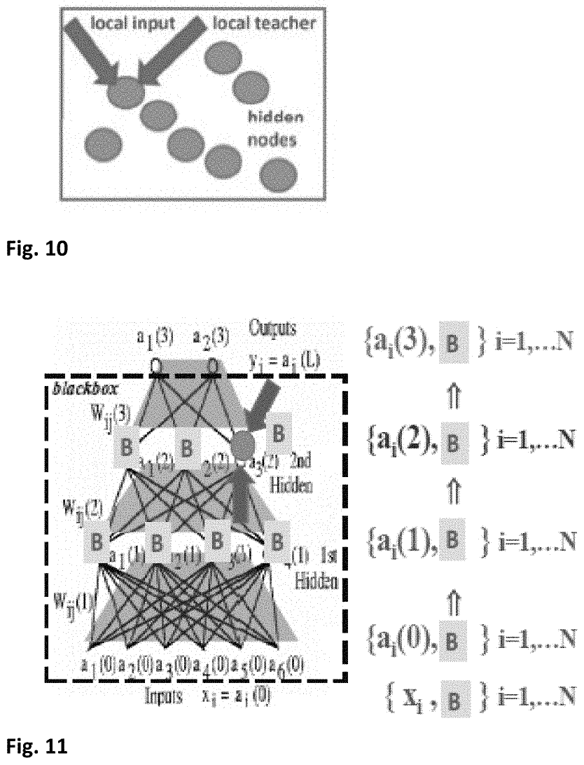

As shown in FIGS. 10 and 11, in addition to input data at the input nodes, the network receives one kind of desired output value (or label) at the output nodes and also a second kind of (internal) teacher label. The internal teacher labels are made accessible to some or all the hidden nodes by sending teacher labels to some or all the hidden nodes. When the teacher labels are made available to all the hidden nodes, the learning scheme may be referred to as Omnipresent Supervision (OS). This new method of teaching/modifying the network makes use of both (1) the difference between the output of the network and the first desired output value and (2) the score of internal hidden nodes derived from the second kind of internal teacher label (ITL), thereby allowing the hidden nodes to be directly trained and/or evaluated without going through the rather indirect backpropagation process.

For internal learning, we adopt a score for nodes or layers based on a notion of IOM, i.e. an internal metric to facilitate the local learning/optimization process in each hidden node/layer. The score function is used to evaluate critical information embedded in any one of the nodes of any one of the hidden layers and may be expressed as:

DI(W)=function(W;X,ITL)

where W is one of a lower-dimensional or reduced-rank transformation matrix to a subspace or subset of nodes of interest, X is the training dataset, and ITL is the internal teacher labels.

More specifically, since internal learning applies only to classification problems, the training dataset may be expressed in terms of a set of pairs denoted as

[ [symbol] , [symbol] ]=[x₁,y₁],[x₂,y₂], . . . ,[x_{N},y_{N}]

where a teacher value is assigned to each training vector. Letting the “center-adjusted” data matrix X be formed from all the training input vectors: {xᵢ, i=1, . . . , N . . . }, the “center-adjusted” scatter matrix may be denoted as S=XX^{T}, which can be divided into two parts, S_{B} and S_{W}, where S=S_{B}+S_{W}, S_{B} denotes the between-class scatter matrix, and S_{W} denotes the within-class scatter matrix. As a result, in an exemplary embodiment of the invention, the general relation DI(W)=function(W; X, ITL) may be rewritten, pursuant to Fisher's classical discriminant analysis:

$${S}_{W} = {\sum }_{𝓁 = 1}^{L} {\sum }_{j = 1}^{{N}_{𝓁}} [ {x}_{j}^{( 𝓁 )} - {{μ}^{->}}_{𝓁} ] [ {( {x}_{j}^{( 𝓁 )} - {{μ}_{𝓁}}^{->} ]}^{T} \\ {S}_{B} = {\sum }_{𝓁 = 1}^{L} {{N}_{𝓁} [ {{μ}^{->}}_{𝓁} - {μ}^{->} ] [ {{μ}^{->}}_{𝓁} - {μ}^{->} ]}^{T}$$

to obtain a score function associated with all the nodes in a full-layer:

DI=DI(I)=tr([S+ρI]⁻¹S_{B}),

where a ridge parameter (φ is incorporated to safeguard numerical inversion of S.

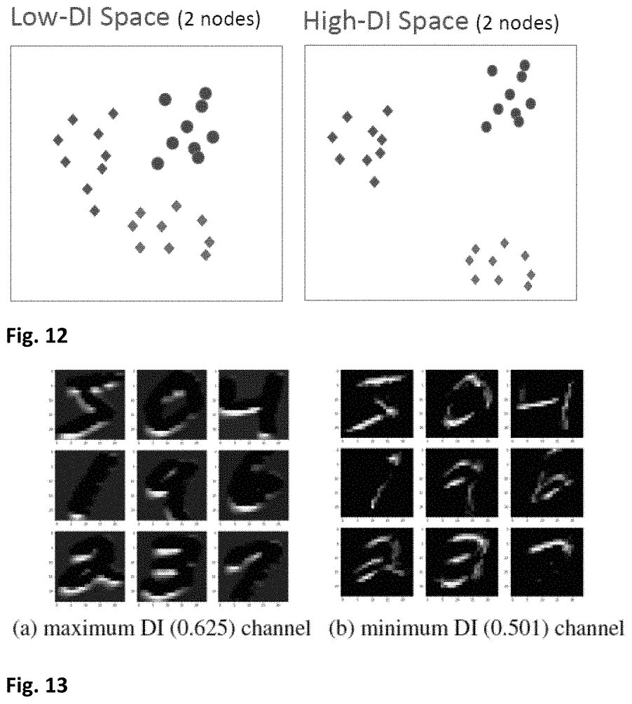

FIG. 12 illustrates mathematically how the TOM scores are closely related to separability of data distributed in all nodes in (or a subset of nodes) in a layer. Because of this relationship, the score may be used to automatically differentiate good and bad layers/nodes—a critical process for node pruning and node selection strategies, and therefore the TOM scores play an instrumental role in our structural learning strategy.

More specifically, the implementation illustrated in FIG. 12 hinges upon training or modifying the network structure using the scores calculated from the second type of Internal Teacher Labels (ITL). For effective node pruning in this implementation, the following score function may be used to effectively and accurately evaluates the critical information embedded in a subspace/node in any hidden layer:

DI(W)=tr([W^{T}SW+ρI]⁻¹[W^{T}S_{B}W])

where W is either a lower-dimensional or reduced-rank transformation matrix to a subspace or subsets of nodes of interest.

To implement node-pruning methods, a Fisher Discriminant Ratio (FDR) is utilize by providing a diagonal matrix W_{i_keep} with all the diagonal elements being equal to “0”, except for the ii-th element, which is assigned a value of “1”:

$${W}_{{i}_{keep}} = [ \begin{matrix}0 & 0 & … & 0 & 0 \\ 0 & ⋱ & … & … & 0 \\ ⋮ & … & \begin{matrix}0 & & \\ & 1 & \\ & & 0\end{matrix} & … & ⋮ \\ 0 & … & … & ⋱ & 0 \\ 0 & 0 & … & 0 & 0\end{matrix} ]$$

It follows that FDR=DI(W_{i_keep}) is the value of the i-th node/channel, a critical information revealing how valuable is the i-th node/channel for the current classification task. For effective node pruning, the lower scoring nodes should be dropped first as they are deemed as the least valuable. FIG. 13 shows real image data to demonstrate the fact that the TOM scores (based on the proposed ITLs) can be effectively used to automatically distinguish the bad nodes from those good ones, and to remove the former in the foregoing pruning process.

An alternative to use of FDR for node trimming or selection is to instead consider the dispensability of the node/channel (DI-Loss), by defining a diagonal matrix W_{i_drop} with all the diagonal elements being equal to “1”, except the ii-th element, which is assigned a value of “0” to show the loss of information upon dropping the i-th node/channel:

$${W}_{{i}_{drop}} = [ \begin{matrix}1 & 0 & … & 0 & 0 \\ 0 & ⋱ & … & … & 0 \\ ⋮ & … & \begin{matrix}1 & & \\ & 0 & \\ & & 1\end{matrix} & … & ⋮ \\ 0 & … & … & ⋱ & 0 \\ 0 & 0 & … & 0 & 1\end{matrix} ]$$

$$Since$$

$$DILoss ≡ DI ( I ) - DI ( {W}_{{i}_{drop}} )$$

represents the value of the remaining nodes in the same layer after removing the i-th node/channel, this implementation effectively reflects the dispensability of the i-th node/channel. Again, for effective node pruning, the lower scoring nodes will be dropped first.

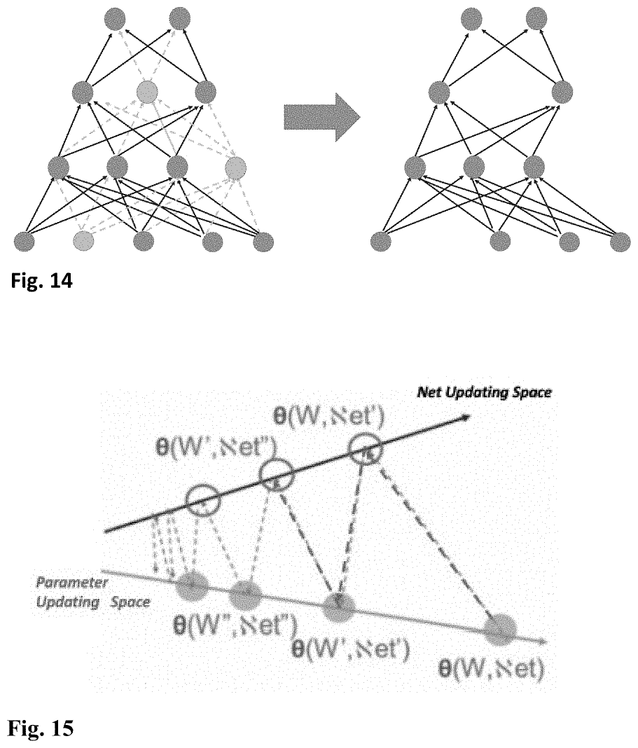

The above-described node trimming or selection strategies can be further understood from FIG. 14, which depicts a neural network before and after trimming. In this figure, yellow-colored nodes in the “before” network depicted on the left indicate nodes to be pruned and blue-colored nodes in both depicted networks indicate nodes to be selected and retained.

In the various implementations of the method of the invention, the combination of internal and external learning paradigms facilitates a structure/parameter NP-iterative learning for (supervised) deep compression/quantization, which simultaneously trims hidden nodes and raises accuracy. FIG. 15 illustrates an NP iterative learning method, in which both backpropagation's EOM (derived from the external teacher labels) and the above-described TOM derived from the internal teacher labels are alternately made use of. The method trims nodes by iteratively repeating: (i) Net Updating to remove the low-score hidden neurons based on the supervised TOM and (ii) Parameter Updating via external backpropagation learning, for example according to the following code:

```
Input : Original Network N et, Pruning Ratio α
Output: Pruned Network N etₚ
Out-source or BP-train a base-net N et, let N etₚ ← N et
while Accuracy ≥ Threshold do
  |  Net Updating: Based on the IOM score, e.g. FDR or DILoss
  |  drop a small fraction of lowest-scored nodes/channels.
  |  Parameter Updating: Based on the EOM score, apply BP to
  |  externally train N et′ into N et″, let N etₚ ← N et″
end
return N etₚ
```

For pruning channels in ConvNets, i.e. convolution networks, a DI-metric similar to the DI-metric described above can be adopted, except that W_{i_keep} W_{i_drop} must be first converted into a block-matrix form:

Wᵢ_{ₖₑₑₚ}⊗I/Wᵢ_{_{drop}}⊗I

so that they are compatible with the dimension of the template channels.

It has been reported by some optimization theoreticians that a somewhat oversized (fat) network may bring about desirable numerical convergence. By starting the NP iteration with a fat DLN, a higher design and flexibility with a broader range of size-performance tradeoff/optimization can be obtained. FIG. 17 illustrates the effect of the pruning strategy on accuracy and processing speed, and demonstrates that the method can yield noticeable improvement in both network reduction and performance enhancement when we start with an oversized (fat) base network.

The method hidden layer modification methods described above may be viewed as a tool for input feature reduction by keeping only a fraction of informative features to retain or improve prediction accuracy. From a discriminant analysis perspective, such feature reduction represents a kind of lossless compression. For certain sensor array applications, it may be applied to save hardware/human costs unnecessarily wasted on raw-data acquisitions.

When applications shift from high accuracy to low power, the hidden nodes may be further quantized according the importance of the nodes or layers, in a process that may be referred to as DI-based Deep Quantization. To this end, the network complexity can be further reduced by downgrading the lower scoring nodes and the associated connections by assigning them a smaller number of bits, both in terms of storage and computations. This quantization may take the form of either horizontal or vertical axis quantization.

Horizontal axis quantization involves differential quantization from one layer to another. However, this can result in a worst case scenario in which quantization-error-variance is amplified by the spectrum norm of the weight matrix whenever it traverses across any layer. Quantization on lower layers tends to induce greater side-effect.

Vertical axis quantization involves application of differential quantization to different nodes, dependent on their TOM scores by either:
(1) cherry-picking a small fraction of the highest FDR nodes, which can achieve order of magnitudes saving in storage from baseline while yielding a respectable accuracy, and/or
(2) downgrading a good fraction of the weaker nodes from 16-bit to 8-bit, which can also save orders of magnitudes in storage while retaining a respectable accuracy.

One effective way of training/modifying the network structure is to bypass some unimportant layers. A DI-type score similar or identical to the ones described above can be used to rank the importance of layers. Usually, lower scoring layers are more likely to be skipped when it becomes necessary to save hardware.

Based on DI-type layer/node ranking as illustrated in FIGS. 8-17, it is possible to effectively automate all of the pruning and selection methods by adopting a strategy which combines the ideas of reinforcement learning and sensitivity analysis. For the classification problem, the teacher labels can be sent from the input layer to all hidden nodes. There are many types of ITLs worthy of consideration. For example, as shown in FIG. 8, the original label is being sent to all hidden nodes to indicate that the currently presenting input vector has the ground truth of belonging to the B label/class, and the label is used to indicate a more detailed ground truth, such as that the input vector is associated with, say, the upper case B, the lower case b, or just a case insensitive label. Moreover, different layers may receive different type of label characterization, i.e. they may be layer-adaptive and, possibly granularity-adaptive (class or super-class). For example, some labels may be case sensitive while other labels may be case insensitive.

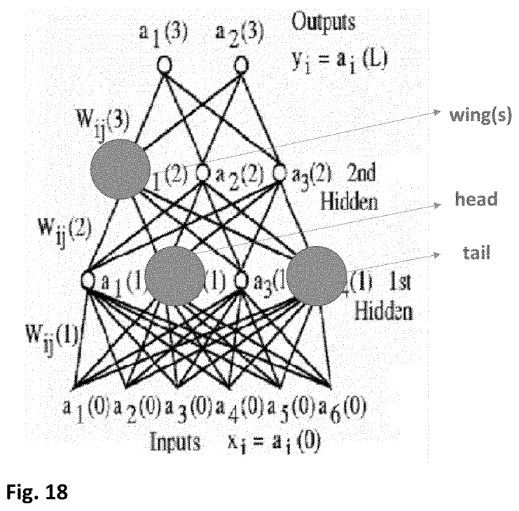

As shown in FIG. 18, the internal label may be designed for end-user XAI explainability. Conceptually, such internal learnability is a step beyond the notion of Internal Neuron's Explainablility (INE), championed by DARPA's XAI (or AI3.0).

Another effective way of training the network structure is growing hidden layers or hidden nodes. In additional to structural learning, DI-based TOM may also be utilized to train a DI-boosting structure, leading to the design of a MINDnet (Monotonic INcreasing Discriminant Network), illustrated in FIGS. 1-6. MINDnet relies on the inheriting Fisher nodes, derived by the OS training strategy (the full-space DI can be retained by the Fisher projection matrix W if and only if it fully spans the (L−1)-dimensional subspace of S_{B}.) MINDnet allows the discriminant information of any hidden layer can be fully transferred to the next layer via a small number of Fisher-nodes. Furthermore, by augmenting the Fisher nodes with the traditional hidden-nodes, it guarantees that the DI will monotonically increase from layer to layer.

As shown in FIG. 1, a system 100 for implementing MINDnet may include a processing device 102, an accelerator circuit 104, and a memory device 106. System 100 can be a computing system or a system-on-a-chip (SoC). Processing device 102 can be a hardware processor such as a central processing unit (CPU), a graphic processing unit (GPU), or a general-purpose processing unit. In one implementation, processing device 102 can be programmed to perform certain tasks including the delegation of computationally-intensive tasks to accelerator circuit 104.

Accelerator circuit 104 may be communicatively coupled to processing device 102 to perform the computationally-intensive tasks using the special-purpose circuits therein. The special-purpose circuits can be an application specific integrated circuit (ASIC), a field programmable gate array (FPGA), a digital signal processor (DSP), network processor, or the like. In one implementation, accelerator circuit 104 may include multiple calculation circuit elements (CCEs) that are units of circuits that can be programmed to perform a certain type of calculations. For example, to implement a neural network, CCE may be programmed, at the instruction of processing device 102, to perform weighted summation. Thus, each CCE may be programmed to perform the calculation associated with a node of the neural network; a group of CCEs of accelerator circuit 104 may be programmed as a layer (either visible or hidden layer) of nodes in the neural network; multiple groups of CCEs of accelerator circuit 104 may be programmed to serve as the layers of nodes of the neural networks. In one implementation, in addition to performing calculations, CCEs may also include a local storage device (e.g., registers) (not shown) to store the parameters (e.g., synaptic weights) used in the calculations. Thus, for the conciseness and simplicity of description, each CCE in this disclosure corresponds to a circuit element implementing the calculation of parameters associated with a node of the neural network. Processing device 102 may be programmed with instructions to construct the architecture of the neural network and train the neural network for a specific task.

Memory device 106 may include a storage device communicatively coupled to processing device 102 and accelerator circuit 104. In one implementation, memory device 106 may store input data 112 to a neural network and output data 114 generated by the neural network. The input data 112 can be feature values extracted from application data such as, for example, image data, speech data etc., and the output data can be decisions made by the neural network, where the decisions may include identification of objects in images or recognition of phrases in speech.

In one implementation, processing device 102 may be programmed to execute a MIND-Net constructor code 108 that, when executed, may identify and parameterize a set of CCEs of accelerator circuit 104 to construct a MIND-Net 110. The implementation of MIND-Net 110 may include a set of CCEs that, at the instruction of MIND-Net constructor 108, are configured to perform a neural network (referred to as MIND-Net). The neural network has the characteristics of monotonically-increasing discriminant (MIND) which ensures performance improvements through each iteration during training of the neural network. To achieve monotonically-increasing discriminant characteristics, each hidden layer of the MIND-Net may be provided an omnipresent supervision (OS) to facilitate training of nodes (referred to as inheritance nodes) that are directly accessible by nodes of the corresponding hidden layer. The inheritance nodes of the omnipresent supervision (OS) is an extension of the hidden layer and can be calculated using a discriminative method (e.g., least square error (LSE) analysis or Fisher linear discriminant analysis) based on the output of a prior layer (e.g., an input layer or a prior hidden layer) of the neural network, where the prior layer in the forward propagation calculates before the current layer. By incorporating the inheritance nodes in hidden layers, the neural networks constructed by MIND-Net constructor 108 may have the characteristics of monotonically-increasing discriminant that improves the overall accuracy of the neural networks. Further, MIND-Net may also effectively solve the curse of the depth problem because the inheritance nodes can fully exploit the OS training strategy.

Implementations of the present disclosure may include a method to construct the MIND-Net on accelerator circuit 104 directly layer by layer. Alternatively, implementations of the present disclosure may convert a neural network implemented without omnipresent supervision (i.e., inheritance nodes in hidden layers) into the MIND-Net.

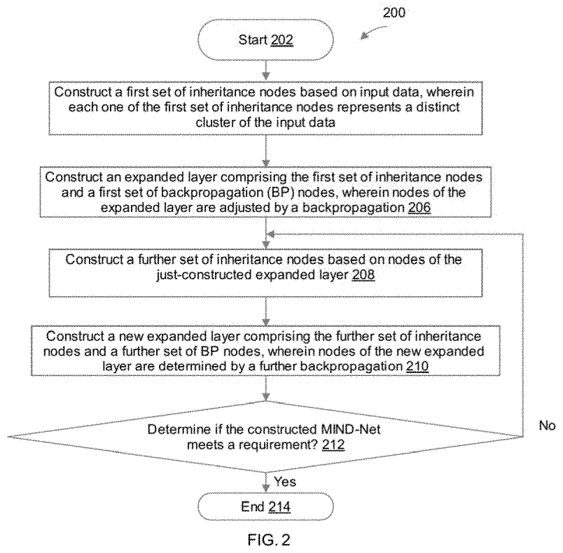

FIG. 2 depicts a flow diagram of a method 200 to construct a MIND-Net according to an implementation of the present disclosure. Method 200 may be performed by processing devices that may comprise hardware (e.g., circuitry, dedicated logic), computer readable instructions (e.g., run on a general purpose computer system or a dedicated machine), or a combination of both. Method 200 and each of its individual functions, routines, subroutines, or operations may be performed by one or more processors of the computer device executing the method. In certain implementations, method 200 may be performed by a single processing thread. Alternatively, method 200 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 200 may be performed by a processing device 102 executing MIND-Net constructor 108 as shown in FIG. 1.

Referring to FIG. 2, at 202, the processing device start execution of code of MIND-Net constructor 108. The start may include read input data 112. In a supervised learning process (i.e., the number of output classes is known in advance), the number of inheritance nodes in hidden layers may be determined as the same as the number (M) of output classes (or as the number of output class minus one (M−1)).

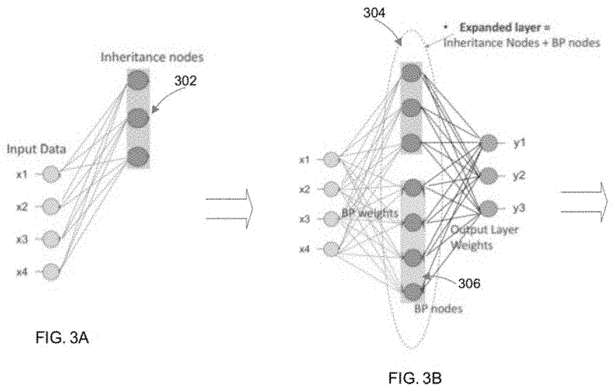

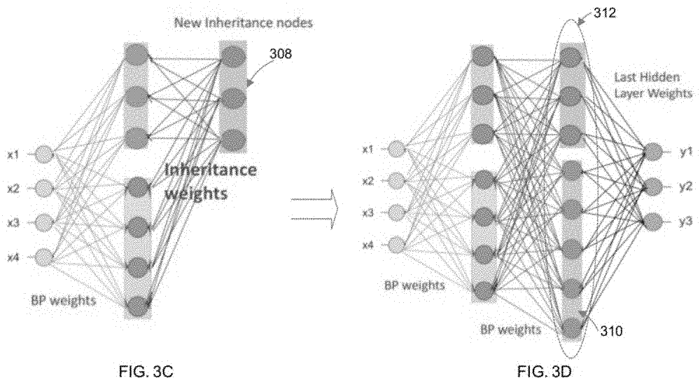

At 204, processing device 102 may execute MIND-Net constructor 108 to configure accelerator circuit 104 to construct a first set of inheritance nodes for the first hidden layer based on input data. The parameters of the first set of inheritance nodes for the first hidden layer may be determined using a discriminative analysis method (e.g., Fisher linear discriminant or LSE). For example, the synaptic weights (W) associated with edges connected to the inheritance nodes may be calculated using Fisher linear discriminant analysis as =S⁻\hat{ }(−1)Δ, where S⁻ is the covariance matrix of the input data and Δ is the inter-class distance vector, assuming that the learning process is a supervised learning where the number of classes is given. For illustration purpose, FIGS. 3A-3D illustrate an exemplary sequence of the construction of a MIND-Net according to the implementation of the present disclosure as shown in FIG. 2. As shown in FIG. 3A, inheritance nodes 402 for the first hidden layer may be constructed based on input data x1-x4 (e.g., using the above-discussed Fisher discriminant analysis), where the input data corresponds to the input layer which is observable from outside of the MIND-net.

Referring to FIG. 2, at 206, processing device 102 may execute MIND-Net constructor 108 to configure accelerator circuit 104 to construct the first hidden layer. The first hidden layer may be converted into an expanded layer including the first set of inheritance nodes and a first set of backpropagation nodes. Processing device 102 may execute MIND-Net constructor 108 to perform a forward propagation and a backpropagation on all nodes in the first expanded layer to adjust parameters of nodes in the first expanded layer. Referring to the example shown in FIG. 3B, processing device 102 may execute MIND-Net constructor 108 to configure accelerator circuit 104 to construct backpropagation nodes 306 in expanded layer 304. The construction may include a forward propagation from input data x1-x4 to output y1-y3, and a backpropagation from output y1-y3 to input x1-x4. The backpropagation may adjust the parameters of the nodes (both backpropagation nodes and inheritance nodes) of the expanded layer.

Referring to FIG. 2, at 208, processing device 102 may execute MIND-Net constructor 108 to configure accelerator circuit 104 to construct a second set of inheritance nodes based on nodes in the just-constructed expanded layer (i.e., the first expanded layer 304). The second set of inheritance nodes may include the same number of inheritance nodes as the first set of inheritance nodes of the first expanded layer. Similar to the first set of inheritance nodes, the second set of inheritance nodes may be calculated using a discriminative analysis method. Thus, the second set of inheritance nodes may serve as the omnipresent teacher for the second expanded layer. As shown in FIG. 3C, inheritance nodes 308 for the second hidden layer may be constructed based on nodes of the first expanded layer 304 using a discriminative analysis method.

Referring to FIG. 2, at 210, processing device 102 may execute MIND-Net constructor 108 to configure accelerator circuit 104 to construct the second hidden layer. The second hidden layer can be an expanded layer including the second set of inheritance nodes and a second set of backpropagation nodes. Processing device 102 may execute MIND-Net constructor 108 to perform a forward propagation and a backpropagation on all nodes to adjust parameters of those nodes (including those in the first expanded layer and the second expanded layer). Referring to the example shown in FIG. 3D, processing device 102 may execute MIND-Net constructor 108 to configure accelerator circuit 104 to construct backpropagation nodes 310 in the second expanded layer 312.

Referring to FIG. 2, at 212, processing device 102 may determine whether the constructed MIND-net meets a requirement specified for the MIND-Net. The performance requirement can be measured in terms of the classification errors made by the MIND-Net with respect to validation data. The validation data can be a set of data that is independent from the training data. After the parameters of the MIND-net are determined in the training process using the training data, the validation data can be used to verify whether the MIND-net can generate accurate decisions with respect to the validation data. If the constructed MIND-net can generate decisions, for validation data, that meet a pre-determined accuracy, the construction of MIND-net may stop. If the constructed MIND-net does not meet the accuracy requirement, the construction of MIND-net may continue by adding another layer of nodes. Alternatively, the requirement can be a pre-determined number of layers assigned to the MIND-Net (e.g., 100 layers). If processing device 102 determines that the constructed MIND-Net meets the requirement, processing device 102 may end the construction of MIND-Net. If processing device 102 determines that the constructed MIND-Net does not meet the requirement, processing device 102 may execute MIND-Net constructor 108 to repeat 208, 210 to add additional expanded layers to the MIND-Net until the constructed MIND-Net meets the requirement.

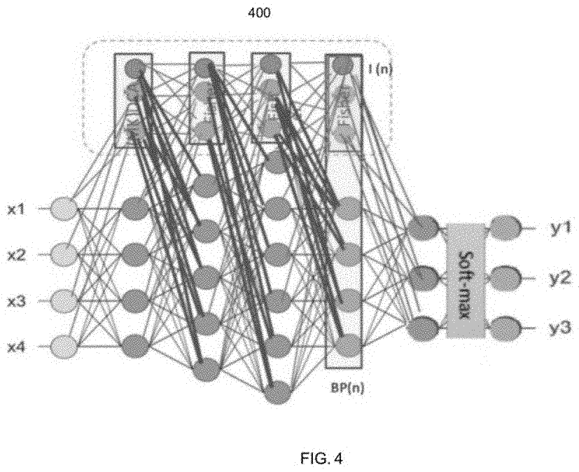

FIG. 4 illustrates a completed MIND-Net 400 according to another implementation of the present disclosure. As shown in FIG. 4, MIND-Net 400 may include a first portion of inheritance nodes (I(n)) and a second portion of backpropagation nodes (BP(n)), where n represents an integer index for layers of MIND-Net 400. As shown in FIG. 4, each hidden layer may be expanded to include a corresponding set of inheritance nodes and a corresponding set of backpropagation nodes. In practice, the number of backpropagation nodes is significantly larger than the number of inheritance nodes (e.g., 1000 vs. 20). Thus, the addition of inheritance nodes may significantly improve the performance without introducing much more computation.

The MIND-Net constructed according to the method described in FIG. 2 is built by incrementally adding layers. Because of the incremental addition of layers, the constructed MIND-Net consumes the hardware resources (e.g., CCEs of the accelerator circuit 104) efficiently. Further, because of the inheritance nodes in each expanded layer are constructed based on discriminative analysis, each additional expanded layer may provide monotonically-increasing discriminant, thus improving the performance of the neural network and significantly mitigate the curse-of-depth problem.

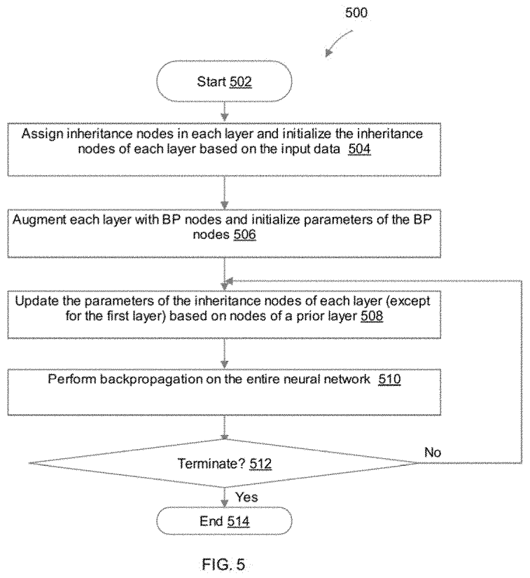

While FIG. 2 depicts a method to sequentially construct a MIND-Net from scratch, existing neural networks can also be converted into MIND-Nets. FIG. 5 depicts a flow diagram of a method 500 to construct a MIND-Net by augmenting layers with backpropagation nodes according to an implementation of the present disclosure. Referring to FIG. 5, at 502, processing device 102 may start the method to construct a MIND-Net by augmenting layers with backpropagation nodes.

At 504, processing device 102 may identify an N-layer neural network, where N is an integer greater than three (3). The processing device may further identify K inheritance nodes for each layer, where K is an integer number. In one implementation, K corresponds to the number of classes (or the number of classes minus one) that is known in a supervised learning. In another implementation, K corresponds to the number of input nodes. The processing device 102 may further initiate parameters (e.g., the synaptic weights of edges connecting to the node) associated with the inheritance nodes of each layer based on the input data using the Fisher discriminant analysis as discussed above (W=S⁻\hat{ }(−1)Δ, where S⁻ is the covariance matrix of the input data and A is the inter-class distance vector). The inheritance nodes of each layer may be initiated similarly based on the input data.

At 506, the processing device 102 may further augment each layer with backpropagation nodes. The number (M) of backpropagation nodes in each layer may exceed the number of inheritance nodes in the same layer. The processing device 102 may further initiate parameters associated with edges connecting to backpropagation nodes in each layer. In one implementation, the processing device 102 may initiate these parameters to zeroes. In another implementation, the processing device 102 may initiate these parameters to random values.

At 508, the processing device 102 may update the parameters (synaptic weights) associated with inheritance nodes of each layer in a forward propagation from the input layer to the output layer. In the forward propagation, the calculation is based nodes of the prior layer. Because the parameters of the inheritance nodes of the first layer are calculated based on the nodes of the input layer and already calculated at 504, the update to the inheritance nodes of the first layer can be omitted. For each subsequent layer, the synaptic weights of each inheritance node may be updated based on all nodes (both inheritance nodes and backpropagation nodes) of the prior layer. The update is carried out in a forward propagation fashion from the first layer to the last layer. In another implementation, the processing device may calculate the parameters associated with inheritance nodes based on more than one layers including prior or subsequent layers. In one implementation, in an all-in implementation, the processing device may calculate the parameters based all layers of the neural network even including the input layer and the output layer. In another implementation, the processing device may select a subset of layers based on a discriminant analysis (e.g., LSE or Fisher linear discriminant analysis). The select subset of layers selected in the forward propagation are those most discriminant layers which may apply most impacts on the parameters.

At 510, the processing device 102 may further perform a backpropagation on the entire neural network 510 from the output layer to the input layer. The backpropagation can update the parameters (synaptic weights) associated with all nodes including the inheritance nodes and backpropagation nodes.

At 512, the processing device may determine whether to terminate the training of the neural network. For example, the processing device 102 may use validation data as the input data to determine whether the accuracy of the neural network reaches the target performance metrics. If the performance reaches the target performance metrics, at 514, the processing device may end the training. However, if the performance has not reached the target performance metrics, the processing device 102 may go back to 508 to repeat 508 and 510.

The MIND-Net as constructed using method 500 may exhibit the same or substantially the same characteristics of MIND-Net constructed using method 200 as shown in FIG. 2. The characteristics may include monotonically-increasing discriminant and mitigation of the curse of the depth.

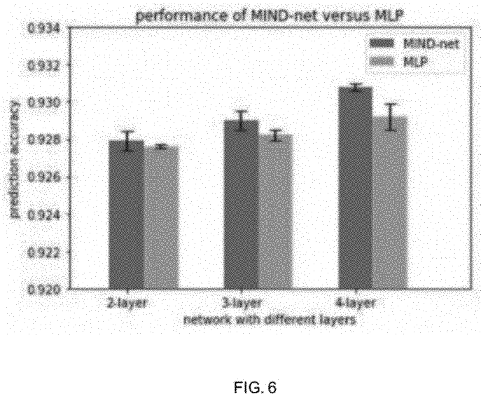

FIG. 6 illustrates an accuracy comparison of the MIND-Net with a backpropagation neural network according to an implementation of the present disclosure. The MIND-Net and a standard ResNet56 are run on CIFAR-10 image database. CIFAR-10 image database contains 60000 32×32 images in 10 classes, with 6000 images per class. There are 50000 training images and 10000 test images. ResNet56 uses a residual learning approach which relies on backpropagation without omnipresent supervision in hidden layers. As shown in FIG. 6, the MIND-Net is more accurate than ResNet56 in 2-layer, 3-layer, and 4-layer network. In particular, the results show that MIND-Net may improve the accuracy more sharply with more layers while ResNet56 shows less improvements with more layers.

FIG. 7 is a block diagram of a computer system operating in accordance with one or more aspects of the implementations illustrated in FIGS. 1-6 and 8-18. In various illustrative examples, computer system 700 may correspond to the system 100 of FIG. 1. In certain implementations, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 may include a processing device 702, a volatile memory 304 (e.g., random access memory (RAM)), a non-volatile memory 706 (e.g., read-only memory (ROM) or electrically-erasable programmable ROM (EEPROM)), and a data storage device 716, which may communicate with each other via a bus 708.

Processing device 702 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 700 may further include a network interface device 722. Computer system 700 also may include a video display unit 710 (e.g., an LCD), an alphanumeric input device 712 (e.g., a keyboard), a cursor control device 714 (e.g., a mouse), and a signal generation device 720. Data storage device 716 may include a non-transitory computer-readable storage medium 724 on which may store instructions 726 encoding any one or more of the methods or functions described herein, including instructions of the constructor of MIND-net 108 of FIG. 1 for implementing methods 200 and 300. Instructions 726 may also reside, completely or partially, within volatile memory 704 and/or within processing device 702 during execution thereof by computer system 700, hence, volatile memory 704 and processing device 702 may also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by a computer system that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium. However, the methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

Finally, as indicated above, the description of the invention herein is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

I claim:

1. A method of implementing a neural network having an input layer made up of a plurality of input layer nodes, an output layer made up of a plurality of output layer nodes, and a plurality of hidden layers connected between the input layer and the output layer, each hidden layer including a plurality of hidden layer nodes, wherein the input, hidden, and output nodes include processing elements for processing data received from nodes of a previous layer, the data flowing in a forward direction from an input to an output of the neural network sequentially through the input layer, the hidden layers, and the output layer, wherein output data is compared with a target represented by an output label, and wherein a result of the comparison between the output data and the output label is used to modify hidden nodes, comprising the steps of:
instead of modifying the hidden nodes by backpropagation from the output to the input through the hidden layers in a reverse sequence, modifying the hidden layers by:
(a) supplying input data, said output label and internal teaching labels to the neural network,
(b) causing the neural network to process the input data through the hidden layers and outputting a result of the processing for comparison with the output label,
(c) supplying the internal teaching labels to the hidden layers and calculating scores for the hidden layers based on the internal teaching labels,
(d) modifying the hidden layers based on the calculated scores and the comparison of the processing result with the output label.

2. A method of implementing a neural network as claimed in claim 1, wherein the step of calculating scores for the hidden layers comprises a step of calculating the following score function of W, X, and ITL, to evaluate critical information embedded in any one of the nodes of any one of the hidden layers:
DI(W)=function(W;X,ITL)
where W is one of a lower-dimensional or reduced-rank transformation matrix to a subspace or subset of nodes of interest, X is the training dataset, and ITL is the internal teacher labels.

3. A method of implementing a neural network as claimed in claim 1 or 2, wherein the step of calculating scores for the hidden layers comprises a step of calculating the following score function to evaluate critical information embedded in any one of the nodes of any one of the hidden layers:
DI(W)=tr([W^{T}SW+ρI]⁻¹[W^{T}S_{B}W]),
where W is one of a lower-dimensional or reduced-rank transformation matrix to a subspace or subset of nodes of interest, S is a center-adjusted scatter matrix given by S=XX^{T}=S_{B}+S_{W}, S_{B} denotes a between-class scatter matrix and S_{W} denotes a within-class scatter matrix calculated by Fisher's Classical discriminant analysis, and ρ is a ridge parameter incorporated to safeguard numerical inversion of S.

4. A method of implementing a neural network as claimed in claim 3, wherein a score of selected nodes is given by DI(W_{i_keep}), wherein W_{i_keep}, is a diagonal matrix and:
$${W}_{{i}_{keep}} = [ \begin{matrix}0 & 0 & 0 & … & 0 & 0 & 0 \\ 0 & 1 & 0 & & & 0 & 0 \\ 0 & 0 & ⋱ & … & … & 0 & 0 \\ ⋮ & … & & \begin{matrix}1 & & \\ & 0 & \\ & & 0\end{matrix} & … & ⋮ & \begin{matrix}0 \\ ⋮\end{matrix} \\ 0 & … & & … & {1}_{⋱} & 0 & 0 \\ 0 & 0 & 0 & … & 0 & 0 & 0 \\ 0 & 0 & 0 & … & 0 & 0 & 0\end{matrix} ]$$
where “0”s on the diagonal indicate dropping the corresponding nodes and “1”s on the diagonal indicate retaining the corresponding nodes.

5. A method of implementing a neural network as claimed in claim 4, wherein the neural network is a convolution network, and a value of “0” or “0”s on the diagonal of the diagonal matrix Wi_keep indicate dropping one or multiple corresponding image channels and a value of “1” or “1”s on the diagonal of the diagonal matrix Wi_drop indicate retaining one or multiple corresponding image channels.

6. A method of implementing a neural network as claimed in claim 3, wherein loss of information upon dropping some selected nodes is shown by a diagonal matrix wherein DI-Loss (W_{i_drop})≡DI(I)−DI(W_{i_drop}), and:
$${W}_{{i}_{drop}} = [ \begin{matrix}1 & 0 & 0 & … & 0 & 0 & 0 \\ 0 & 0 & 0 & & & 0 & 0 \\ 0 & 0 & ⋱ & … & … & 0 & 0 \\ ⋮ & … & & \begin{matrix}1 & & \\ & 0 & \\ & & 1\end{matrix} & … & ⋮ & \begin{matrix}0 \\ ⋮\end{matrix} \\ 0 & … & & … & ⋱ & 0 & \\ 0 & 0 & 0 & … & 0 & 0 & 0 \\ 0 & 0 & 0 & … & 0 & 0 & 1\end{matrix} ]$$
where “0”s on the diagonal indicate dropping the corresponding nodes and “1”s on the diagonal indicate retaining the corresponding nodes.

7. A method of implementing a neural network as claimed in claim 6, wherein the neural network is a convolution network, and a value of “0” or “0”s on the diagonal of the diagonal matrix W_{i_keep} indicate dropping one or multiple corresponding image channels and a value of “1” or “1”s on the diagonal of the diagonal matrix W_{i_drop} indicate retaining one or multiple corresponding image channels.

8. A method of implementing a neural network as claimed in claim 7, wherein the score of selected channels is given by DI(W_{i_keep}) and the loss of information upon dropping the channels is given by
DI-Loss(W_{i_drop})≡DI(I)−DI(W_{i_drop}).

9. A method of implementing a neural network as claimed in claim 1, wherein the step of modifying the network structure comprises the step of pruning hidden nodes dropping lower scoring nodes.

10. A method of implementing a neural network as claimed in claim 1, wherein the step of modifying the network structure comprises the step of reducing a number of bits in computations and outputs.

11. A method implementing a neural network as claimed in claim 10, wherein the step of reducing a number of bits is dependent on the scores of nodes.

12. A method of implementing a neural network as claimed in claim 1, wherein the step of modifying the network structure comprises the step of by-passing lower scoring nodes.

13. A method of implementing a neural network as claimed in claim 1, further comprising the step of modifying the neural network by adding hidden layers or hidden nodes.

14. A method of implementing a neural network as claimed in claim 13, wherein the step of adding hidden layer or hidden nodes includes an iterative process that includes steps of:
(a) adding a first set of inheritance nodes to a first hidden layer using a discriminative analysis of input data;
(b) performing both a forward propagation of the input data and a backpropagation from the output to adjust parameters of the first set of inheritance nodes and original nodes of the first hidden layer;
(c) adding a second set of inheritance nodes to a second hidden layer using the discriminative analysis of input data processed by the first hidden layer; and
(d) using the second set of inheritance nodes as a teacher for the second hidden layer by performing forward propagation of the input data and backpropagation from the output to adjust parameters of the second set of inheritance nodes and original nodes of the second hidden layer.

15. A method of implementing a neural network as claimed in claim 14, wherein the discriminative analysis of input data includes a step of calculating synaptic weights associated with edges connected to the inheritance nodes using Fisher linear discriminant analysis, by calculating S̅⁻¹ Δ, where S̅⁻¹ is an inverse covariance matrix of the input data and A is an inter-class vector for a supervised learning process where a number of number of classes is given.

16. A method of implementing a neural network as claimed in claim 1, wherein the step of modifying the hidden layers includes the step of modifying activation functions of the hidden nodes based on the calculated scores.

17. A method of implementing a neural network as claimed in claim 1, further comprising the step of supplying the output label to selected said hidden layers, wherein the step of calculating scores for the hidden layers based on the internal teaching labels is alternated with a step of calculating scores for the hidden layers based on the output label.

18. A method of implementing a neural network as claimed in claim 1, wherein the output label is a continuous value or a discrete label, and the internal teaching labels are discrete labels.

19. A method of implementing a neural network as claimed in claim 1, wherein the internal teaching labels are selected for end-user XAI explainability.

20. A method of implementing a neural network as claimed in claim 1, wherein the internal teaching labels are different for different hidden layers.

21. A method of implementing a neural network as claimed in claim 1, further comprising a step of modifying multiple network structures by using and cross-referencing calculated hidden layer scores of multiple networks.

22. A method of implementing a neural network as claimed in claim 1, wherein the internal teaching labels are also used to evaluate layer sizes of modified network structures.

23. A system for implementing a neural network, comprising:
a processing device;
an accelerator circuit; and
a memory device, wherein:
the processing device is configured to perform certain tasks including the delegation of computationally-intensive tasks to the accelerator circuit, and
the accelerator circuit is communicatively coupled to processing device using multiple calculation circuit elements that are units of circuits programmed to predetermined types of calculations, at least some of which form a neural network having an input layer, and output layer, and at least one hidden layer, wherein the neural network is implemented according to the method of claim 1.
